(19) United States
(12) Patent Application Publication
(10) Pub. No.: US 2026/0331791 A1
(43) Pub. Date: Oct. 22, 2026

(54) CONDUCTOR CONNECTION TERMINAL AND ELECTRICAL PLUG CONNECTOR

(71) Applicant: WAGO Verwaltungsgesellschaft mbH, Minden (DE)

(72) Inventors: Paul-Sebastian SCHETTLER, Sondershausen (DE); Finn Paul WELLING, Spenge (DE); Joel PALTEN, Bad Oeynhausen (DE); Henning MEIER, Bueckeburg (DE)

(73) Assignee: WAGO Verwaltungsgesellschaft mbH, Minden (DE)

(21) Appl. No.: 19/647,130

(22) Filed: Apr. 14, 2026

(30) Foreign Application Priority Data
Apr. 16, 2025 (DE) 20 2025 102 089.0

(51) Int. Cl. H01R 4/48

(52) U.S. Cl. CPC H01R 4/4833

(57) ABSTRACT

A conductor connection terminal with a housing and multiple spring-loaded clamping connections, each of which has at least one clamping spring for connecting an electrical conductor via elastic force. For multiple or all of these spring-loaded clamping connections, the conductor connection terminal in each case has an individual actuating element that is associated with each spring-loaded clamping connection and individually manually actuatable, and as a result of its manual actuation the clamping spring of the associated spring-loaded clamping connection is actuatable into an open position individually, i.e., independently of the other clamping springs. Also provided is an electrical plug connector, in particular a circular plug connector, having at least one such conductor connection terminal.

This nonprovisional application claims priority under 35 U.S.C. § 119(a) to German Patent Application No. 20 2025 102 089.0, which was filed in Germany on Apr. 16, 2025, and which is herein incorporated by reference.

### BACKGROUND OF THE INVENTION

### Field of the Invention

The invention relates to a conductor connection terminal with a housing and multiple spring-loaded clamping connections, each of which has at least one clamping spring for connecting an electrical conductor by means of elastic force, wherein for multiple or all of these spring-loaded clamping connections, the conductor connection terminal in each case has an individual actuating element that is associated with each spring-loaded clamping connection and individually manually actuatable, and as a result of its manual actuation the clamping spring of the associated spring-loaded clamping connection is actuatable into an open position individually, i.e., independently of the other clamping springs. The invention further relates to an electrical plug connector, in particular a circular plug connector, having at least one such conductor connection terminal.

### Description of the Background Art

A conductor connection terminal is known from EP 2 956 992 B1, which corresponds to US2016/0006176, which is incorporated herein by reference.

### SUMMARY OF THE INVENTION

It is therefore an object of the invention to provide a further improved conductor connection terminal.

For a conductor connection terminal of the type mentioned at the outset, this object is achieved in an example in that the conductor connection terminal has at least one manually actuatable rotary actuating element that is rotatably supported on the housing, and as a result of its manual actuation via a rotational movement, the clamping springs of multiple or all spring-loaded clamping connections are jointly actuatable into the open position. The invention allows the user of such a conductor connection terminal, depending on the requirements and the situation, to either actuate individual clamping springs or only one clamping spring into the open position by actuating the particular individual actuating element, or alternatively, to jointly actuate the clamping springs of all spring-loaded clamping connections, which are actuatable via the overall actuating element into the open position, by actuating the rotary actuating element, which thus forms an overall actuating element for multiple or all clamping springs. The joint actuation of multiple or all spring-loaded clamping connections via the overall actuating element is helpful, for example, when the conductor connection terminal is to be wired for the first time. On the other hand, if partial rewiring is to take place at a conductor connection terminal that is already wired, it is often desirable not to actuate all clamping springs into the open position, but, rather, to actuate only those clamping springs for which rewiring is to take place. For this purpose, individual actuating elements may then be actuated by the user in a targeted manner. By use of the overall actuating element, for example the clamping springs may be directly actuatable into the open position; i.e., the overall actuating element may act directly on the clamping springs.

The individual actuating elements may be manually actuated directly by the user without the need for an additional tool. It is also conceivable for the individual actuating elements to be designed in such a way that actuation is additionally possible by means of a tool, or is possible only by means of a tool. The individual actuating elements may be actuated in particular at a particular manual actuating section at a location on the outer side of the housing of the conductor connection terminal or in an actuation channel of the housing. The overall actuating element may advantageously be manually actuated directly by the user without an additional tool. The housing of the conductor connection terminal may be designed as an insulation material housing.

Furthermore, with the conductor connection terminal according to the invention it is advantageously possible to jointly actuate the multiple or all clamping springs into the open position by means of the overall actuating element, and then, after connecting the electrical conductors to the spring-loaded clamping connections, to transfer a particular individual clamping spring into the clamped position, in which an electrical conductor is clamped to the spring-loaded clamping connection, by actuating the particular individual actuating element.

As a result of designing the overall actuating element as a rotary actuating element, the user can actuate the conductor connection terminal in a comfortable, ergonomic manner. Relatively large forces may be applied by means of the rotary actuating element, so that a fairly large number of clamping springs can be simultaneously tensioned when the rotary actuating element is rotated, for example due to their clamping legs being displaceable into the open position.

Each of the spring-loaded clamping connections may have a busbar with a contact section for connecting an electrical conductor. The clamping springs may each have a clamping leg for connecting an electrical conductor. The clamping leg may be deflectable into the open position by the individual actuating element and the rotary actuating element. The clamping leg together with the contact section of the busbar may form a clamping point for connecting an electrical conductor between the clamping leg and the contact section. An open clamping point (open position) is characterized in that at least one clamping edge of the clamping leg is swiveled away from the contact section of the busbar, i.e., is farther away from the contact section than in a clamped position. The clamping leg may be swiveled, for example between the open position in which the electrical conductor is freely movable between the clamping leg and the contact section, and the clamped position in which the clamping leg connects the electrical conductor to the contact section.

The rotary actuating element can be configured to indirectly actuate the particular clamping spring into the open position by actuating the individual actuating element associated with this clamping spring. In this way, the conductor connection terminal enables an indirect clamping point opening by means of a rotary actuation.

The rotary actuating can have a main body from which multiple actuating arms protrude in the axial direction, wherein each actuating arm is configured to transmit an actuating force from the rotary actuating element to each individual actuating element or to a clamping leg for deflecting the particular clamping leg into the open position. The actuating force may thus be transmitted from the rotary actuating element to the individual actuating elements or clamping legs in a targeted manner. The individual actuating elements may thus be situated at an ergonomically favorable position at the conductor connection terminal, so that they are also easily accessible for the individual manual actuation.

For example, each individual actuating element may have a grip section at which the individual actuating element is to be manually actuated. The grip sections may in each case be accessible at the outer side of the housing and correspondingly manually actuatable. The manual actuation may take place either directly using a finger, i.e., without a tool, or by using a tool. The grip sections of the individual actuating elements may, for example, all be situated at the same housing side of the conductor connection terminal, for example at a housing side at which the conductor insertion openings for the spring-loaded clamping connections are also present. The grip sections may also be situated at various housing sides of the conductor connection terminal. If the conductor connection terminal has a circular housing, the grip sections may be situated, for example, on the circumferential face of the circular housing shape.

At least one actuating contour can extend at an angle to the rotational direction of the rotary actuating element is formed at the particular actuating arm, and via which each individual actuating element or clamping leg may be acted on with the actuating force from the rotary actuating element. Due to such an angled actuating contour, or in other words an actuating bevel which may be shaped like a ramp, for example, efficient transmission of the actuating force from the rotary actuating element to the individual actuating elements or clamping legs is possible.

At the particular individual actuating element, for example at its grip section, a force absorption contour that is shaped as a counterpart to the angled actuating contour of the actuating arm may be present which, for example, likewise extends at an angle to the rotational direction of the rotary actuating element, for example in parallel to the actuating contour of the actuating arm.

The particular actuating contour can be configured to apply an actuating force to each individual actuating element or to a clamping leg, the actuating force having at least one force component acting in the axial direction and/or at least one force component acting in the radial direction. The axial and radial directions refer to the rotational axis of the rotary actuating element about which the rotary actuating element is rotatable.

As a result of such a force component acting in the axial direction, an individual actuating element may be moved, for example, in the axial direction, for example in the longitudinal direction of a circular housing of the conductor connection terminal, by rotating the rotary actuating element. This type of actuation is well suited, for example, for individual actuating elements that are designed as push actuators or actuation sliders and are supported so as to be displaceable in a displacement direction.

The force component acting in the radial direction is well suited for actuating individual actuating elements, which may be designed as swivelable actuating levers. For example, the force component acting in the radial direction may be active in the radially outwardly pointing direction. By means of this force component, an individual actuating element or its grip section may then be swiveled radially outwardly with respect to the outer contour of the housing.

One, multiple, or all individual actuating elements can be designed as swivelable actuating levers or as displaceable push actuators or some other type of sliding actuation element. With regard to the actuating elements, the conductor connection terminal may thus be optimally adapted to the particular purpose, depending on whether a level actuation, push actuation, or slide actuation is more advantageous. A displaceable push actuator may be characterized in that it is displaceably situated in an actuation shaft of the housing and may be actuated by applying a pressure actuating force to an end-face surface that is accessible at the outer side of the housing. In contrast, a sliding actuation element, although it can carry out a displacement movement like that of a push actuator, may be actuated via a manual actuating section that is supported at the outer side of the housing and displaceable along the outer side.

The spring-loaded clamping connections can be arranged in a circular shape in the housing of the conductor connection terminal. The spring-loaded clamping connections arranged in a circular shape annularly surround the center of the housing of the conductor connection terminal.

The rotary actuating element can have a ring-shaped main body that annularly surrounds the area delimited by the circular shape of the spring-loaded clamping connections. The ring-shaped main body may thus be designed as an actuating ring. The ring-shaped main body may be rotatably supported, for example at the outer side of the housing of the conductor connection terminal.

The rotary actuating element can be configured to be manually actuated at its ring-shaped main body on a circumferential side of a ring-shaped housing of the conductor connection terminal. The ring-shaped main body may thus be easily gripped by hand, ensuring good force transmission.

The individual actuating elements can be configured to be actuated outside the area delimited by the circular shape of the spring-loaded clamping connections. This has the advantage that the user can comfortably actuate the grip sections of the individual actuating elements on the circumferential side of a circular housing of the conductor connection terminal. In particular, the grip section of each individual actuating element may be situated, at least predominantly, outside the area delimited by the circular shape of the spring-loaded clamping connections. It is also possible for each of the individual actuating elements to be situated, at least predominantly, outside the area delimited by the circular shape of the spring-loaded clamping connections.

Alternatively, the individual actuating elements may be configured to be actuated inside the area delimited by the ring-shaped main body. Each of the individual actuating elements may be situated, at least predominantly, inside the area delimited by the ring-shaped main body.

The rotary actuating element can be designed as an actuating element that is rotatable about the longitudinal axis of the circular shape of the spring-loaded clamping connections. Accordingly, the rotational axis of the rotary actuating element extends orthogonally to a plane defined by the circular shape of the spring-loaded clamping connections.

Upon reaching the open position, one, multiple, or all individual actuating elements can be in each case fixable to at least one component of the conductor connection terminal or fixable in a top dead center position, wherein in the fixed position of the individual actuating element, the clamping leg is held in the open position by the individual actuating element. This has the advantage that the clamping leg may be held in the open position for an extended period, also without the need for further manual actuation of the particular individual actuating element or of the rotary actuating element. Instead, by use of the rotary actuating element the user may, for example, place all clamping legs in the open position via the individual actuating elements, and this open position is then held via the described functionality of fixing the individual actuating element.

The individual actuating element can have a first detent element with which the individual actuating element is latchable, in the open position, to a second detent element of another component of the conductor connection terminal, in particular the busbar or the insulation material housing. This allows particularly secure fixing of an individual actuating element in the open position of the clamping leg. Due to the latching, the individual actuating element does not accidentally come loose, not even if a vibration load occurs at the conductor connection terminal, for example. Of course, the user can release the latching of the individual actuating element at any time by manual actuation.

The conductor connection terminal can have a release element with a release section in each case for one, multiple, or all spring-loaded clamping connections, via which the fixing or latching of the particular individual actuating element is releasable in the open position and the clamping leg is automatically movable from the open position in the direction of the clamped position when the release section is acted on with a release force by the inserted electrical conductor. The conductor connection terminal may thus be easily expanded to a functionality of the spring-loaded clamping connections with an automatic conductor connection.

The object stated at the outset is further achieved by an electrical plug connector, in particular a circular plug connector, having at least one conductor connection terminal of the type explained above. The advantages explained above may also be achieved by this electrical plug connector.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a conductor connection terminal in a perspective view,

FIG. 2 shows a busbar in a perspective view,

FIG. 3 shows a clamping spring in a perspective view,

FIG. 4 shows a spring-loaded clamping connection in a perspective view,

FIG. 5 shows a spring-loaded clamping connection in the interior of the housing of the conductor connection terminal according to FIG. 1, in a lateral sectional view in the unactuated state,

FIG. 6 shows the arrangement according to FIG. 5 in the open position,

FIG. 7 shows an example of a conductor connection terminal in a perspective view,

FIG. 8 shows an example of a conductor connection terminal in a perspective view,

FIG. 9 shows an individual actuating element of the conductor connection terminal according to FIG. 7 in a perspective view,

FIG. 10 shows a rotary actuating element of the conductor connection terminal according to FIG. 7 in a perspective view,

FIG. 11 shows an example of a rotary actuating element in a perspective view,

FIG. 12 shows a conductor connection terminal with the rotary actuating element according to FIG. 11, in a lateral sectional view in the unactuated state,

FIG. 13 shows the conductor connection terminal according to FIG. 12 when the rotary actuating element is partially actuated, and

FIG. 14 shows the conductor connection terminal according to FIG. 12 when the rotary actuating element is completely actuated.

### DETAILED DESCRIPTION

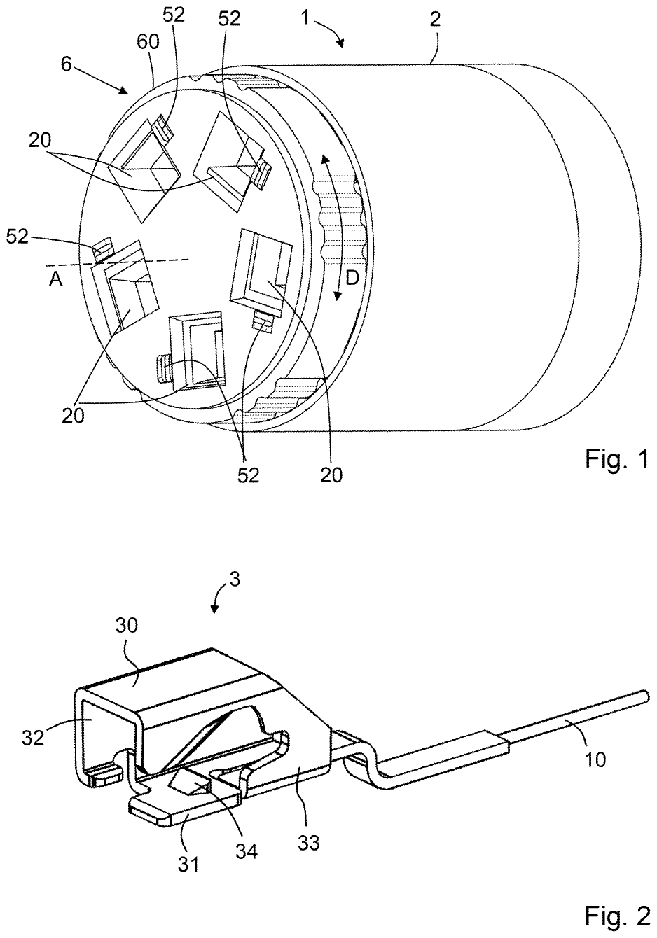

FIG. 1 shows an example of a conductor connection terminal 1 that has an insulation material housing 2. Multiple spring-loaded clamping connections 9 are accommodated in the housing 2. In the illustrated example, the spring-loaded clamping connections are situated along a ring-shaped track around a center in the housing 2, for example on a circular path. However, the invention also relates to conductor connection terminals with different types of housing designs and different arrangements of spring-loaded clamping connections, for example spring-loaded clamping connections situated next to one another in a row.

FIG. 1 shows the conductor connection terminal 1 with a view of a conductor insertion side, in which the housing 2 has a conductor insertion opening 20 for each spring-loaded clamping connection. An electrical conductor may be inserted through the conductor insertion opening 20 and into the housing 2 and connected to the spring-loaded clamping connection.

In addition, for actuating the spring-loaded clamping connections the conductor connection terminal 1 has a rotary actuating element 6 that is configured, for example, to transfer the clamping legs of the clamping springs of all spring-loaded clamping connections into the open position when it is manually actuated. The rotary actuating element 6 may have a ring-shaped main body 60 that is rotatably supported on a circumferential side of the housing 2, and that can be rotated about a rotational axis A in a rotational direction D with respect to the housing 2. The actuating force for rotating the rotary actuating element 6 may be applied directly to the main body 60, in particular at its outer circumferential side. For this purpose, the main body 60 may have fluting or other contours on its circumferential side which increase the grip. For each spring-loaded clamping connection the conductor connection terminal 1 has an individual actuating element, of which only the grip section 52 is visible on the outer side of the housing 2 in FIG. 1, which is used to apply the manual actuating force. The individual actuating element may be designed as a displaceable actuating element in the form of a push actuator or actuation slider.

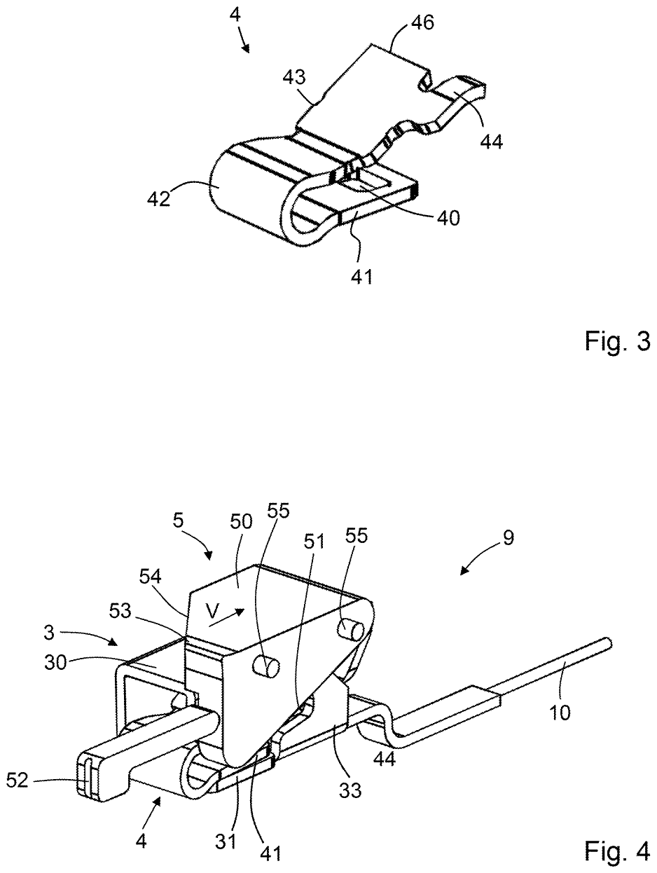

Each spring-loaded clamping connection 9 also has a busbar 3 as illustrated in FIG. 2, for example, and a clamping spring 4 as illustrated in FIG. 3, for example. The busbar 3 has a contact section 30 to which an electrical conductor may be connected. The busbar 3 also has a spring retainer section 31 opposite from the contact section 30, for example essentially parallel thereto, at which, for example, a retaining element 34 for retaining the clamping spring 4 may be situated. The contact section 30 may be connected to the spring retainer section 31 via one or two connecting walls 32, 33. The connecting walls 32, 33 may be designed, for example, as side walls of an area of the busbar 3 having an overall frame-like design. The busbar 3 thus forms a contact frame into which the clamping spring 4 may be inserted.

The conductor connection terminal 1 may be designed as an electrical plug connector, for example. The busbar 3 may then be connected to a plug connection 10 of the plug connector or formed in one piece therewith.

The clamping spring 4 has a contact leg 41, a spring bend 42 adjoining the contact leg 41, and a clamping leg 43 adjoining the spring bend 42. At an end facing away from the spring bend 42, the clamping leg 43 has a clamping edge 46 that is used to connect the electrical conductor to the contact section 30. An actuating section 44, for example in the form of an actuation tab, branches off from the clamping leg 43 at least on one side. The actuating section 44 is used for actuation of the clamping leg 43 by the actuating element 6, as explained in greater detail below. A fastening element 40 is formed at the contact leg 41, for example with an opening extending through the contact leg 41 via which the contact leg 41 may be fastened to the retaining element 34, as illustrated in FIG. 4.

FIG. 4 shows a spring-loaded clamping connection 9 having an arrangement made up of the busbar 3 according to FIG. 2 and the clamping spring 4 according to FIG. 3. The clamping spring 4 is suspended in the contact frame of the busbar 3. The clamping spring 4 now rests with its contact leg 41 on the spring retainer section 31, and thus supports the clamping spring 4 against the force of the clamping leg 43. It is apparent that the actuating section 44 extends laterally from the connecting wall 33. A corresponding opening may be formed in the connecting wall 33 for this purpose. An individual actuating element 5 is also present.

The individual actuating element 5 has a main body 50 at which guide pins 55, which protrude laterally at one longitudinal side or at both opposite longitudinal sides, are situated. The main body 50 also has at least one spring action section 51, for example with an actuating surface which extends at an angle to the displacement direction V of the individual actuating element 5, and which deflects the actuating section 44 of the clamping spring 4 during the displacement movement of the individual actuating element 5. A first detent element 53 is situated at the main body 50. A guide slot 65 is also formed on the main body 60. The individual actuating element 5 also has a grip section 52 which may be formed in one piece with the main body 50, and which as an elongated section protrudes therefrom opposite the displacement direction V. The grip section 52 is configured to apply the manual actuating force.

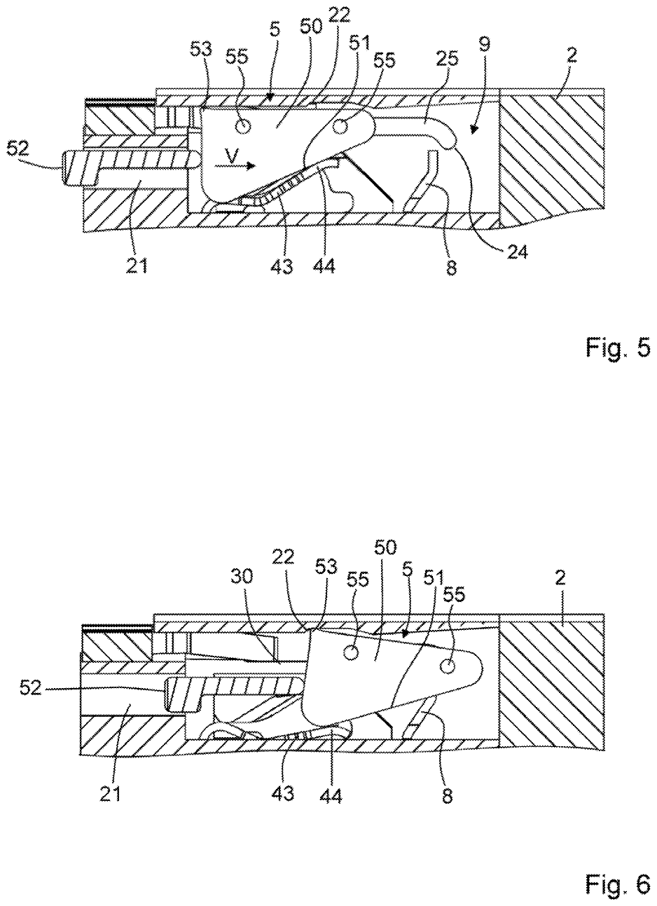

FIG. 5 shows a sectional view of a detail of the conductor connection terminal 1 according to FIG. 1, illustrating the region of a spring-loaded clamping connection 9. It is apparent that the individual actuating element 5 is actuatable at the grip section 52 on the outer side of the housing 2. The grip section 52 may be displaceably supported, for example, in an actuation channel 21 of the housing 2. The main body 50 may be situated completely inside the housing 2. In FIG. 5, the individual actuating element 5 is in a starting position in which the clamping leg 43 or the actuating section 44 is not yet actuated by the spring action section 51. The clamping leg 43 is correspondingly in its clamped position.

The guide pins 55 are guided in a guide groove 25 in the insulation material housing 2. It is apparent that the predominant portion of the guide groove 25 is formed as a linearly extending section that runs in parallel to the displacement direction V. The guide groove 25 has a curved section at the rear end in the direction of the open position. As a result of this curved section 24, the individual actuating element 5 is additionally guided across the guide pins 55 during a swivel movement; i.e., the curved section 24 brings about a swivel movement of the individual actuating element 5.

FIG. 6 illustrates the state in which the individual actuating element 5 is completely actuated. The individual actuating element 5 has now been pushed away from the starting position in the displacement direction V. The clamping leg 43 has been deflected by the spring action section 51 in the direction of the open position. When a certain position is reached during this displacement movement, as illustrated in FIG. 6, the actuating element 6, which thus far has moved linearly in the displacement direction V, can additionally undergo a swivel movement or tilting movement. As a result of this swivel or tilting movement, the first detent element 53 comes into engagement with a second detent element 22 which may be situated at the housing 2, for example. The individual actuating element 5 is thus latched in the open position, and consequently cannot be moved back by the clamping leg 43 in the direction of the starting position. This swivel movement of the individual actuating element 5 can be brought about or at least assisted by the elastic force of the clamping spring 4 that acts on the individual actuating element 5 by the clamping leg 43. The force of the clamping spring 4 thus ensures secure latching between the first detent element 53 and the second detent element 22.

The disconnection, i.e., the release of the latching, preferably takes place by means of an inserted electrical conductor which strikes against a release element 8 of the conductor connection terminal 1. The release element 8 may be situated at the individual actuating element 5, at the busbar 3, or at the housing 2, so that the inserted electrical conductor exerts a force on the individual actuating element 5 via the release element 8, and the individual actuating element 5 thus undergoes a movement that releases the latching.

For example, the release element 8 may be configured to deflect the conductor, which is inserted in a conductor insertion direction parallel to the displacement direction V, so that the free end of the conductor is deflected with respect to the tiltable individual actuating element 5, for example by means of a bevel that is integrally formed on the release element 8. As a result of inserting the conductor, which is deflected at its end and strikes against the individual actuating element 5, the individual actuating element 5 may be released from its position, i.e., tilted back into the position illustrated in FIG. 5, and is pushed back into the starting position by the elastic force of the clamping leg 43. In the process, the conductor is connected by the clamping leg 43.

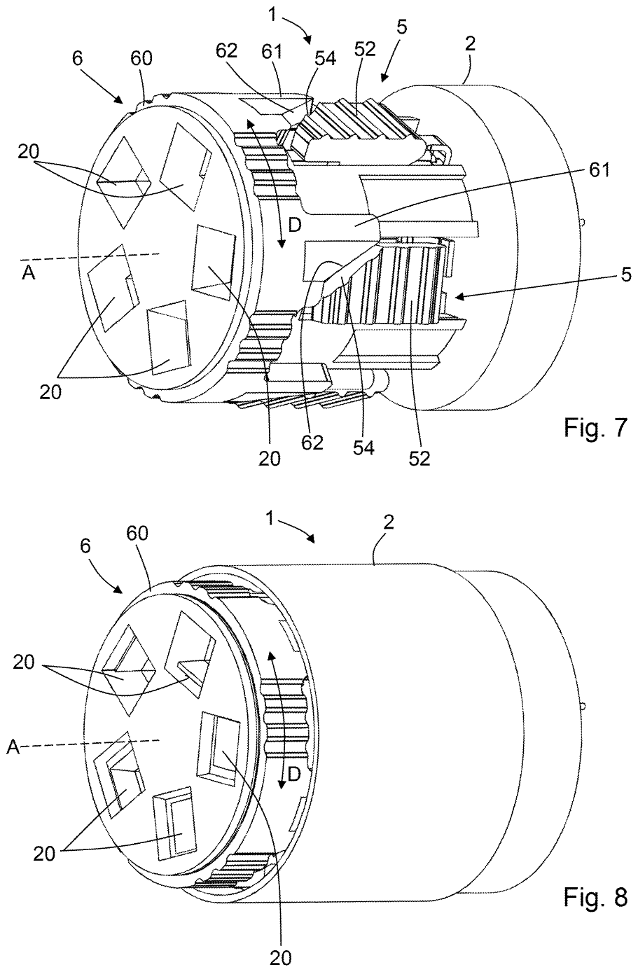

FIG. 7 shows an example of a conductor connection terminal 1 which once again has a circular housing. Once again, a rotary actuating element 6 having a ring-shaped main body 60 is present. Multiple actuating arms 61 protrude from the ring-shaped main body 60 in the axial direction. The actuating arms 61 are each used to transfer an actuating force from the rotary actuating element 6 to an individual actuating element 5. In this case the individual actuating elements 5 are designed as sliding actuation elements, each having a grip section 52 for applying the manual actuating force. For the manual actuation, the grip sections 52 are accessible on a circumferential side of the conductor connection terminal 1.

As a mechanical interface for transferring the actuating force from the rotary actuating element 6 to the particular individual actuating element 5, an actuating contour 62 that is oriented at an angle to the rotational direction D of the rotary actuating element 6 is formed on each actuating arm 61. A force absorption contour 54 at the individual actuating element 5, in particular at the grip section 52, is likewise oriented at an angle to the rotational direction D, and is associated with this angled actuating contour 62. When the rotary actuating element 6 rotates, each actuating contour 62 comes into contact with a force absorption contour 54 and slides along same. The particular individual actuating element 5 is thus displaced in the axial direction, i.e., parallel to the rotational axis A, as a result of which a respective clamping point is opened; i.e., the clamping leg 43 of a clamping spring 4 is displaced from the clamped position into the open position.

FIG. 8 shows a variant of the conductor connection terminal according to FIG. 7, in which the individual actuating elements 5 are situated completely inside the housing 2, and thus have no grip section 52 that is accessible at the outer side of the housing 2. The individual actuating elements 5 are then actuated inside the housing 2 in the above-described manner, for example.

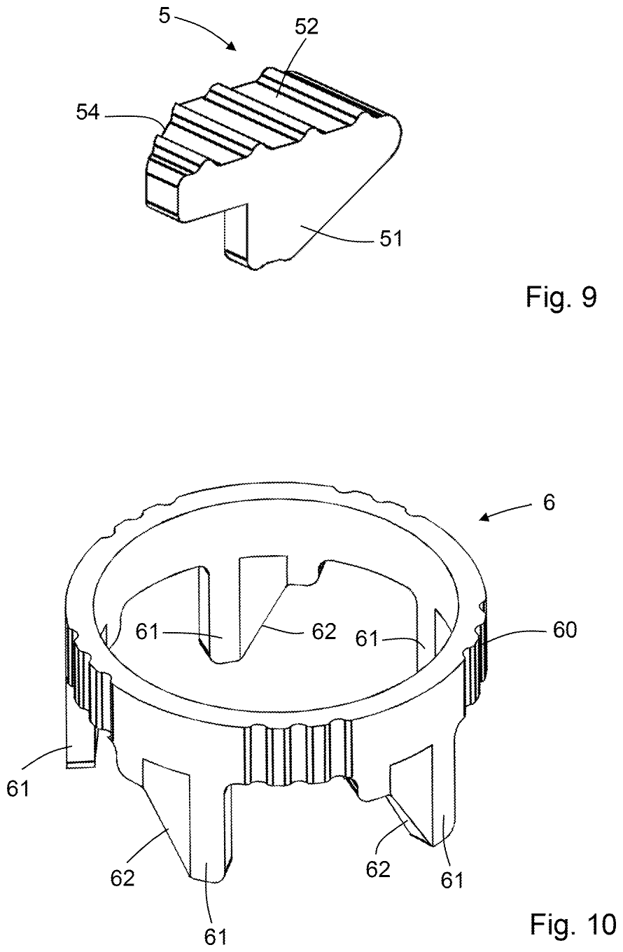

FIG. 9 illustrates the design of a respective individual actuating element 5 in the example of the conductor connection terminal according to FIG. 7. The angled force absorption contour 54 at the grip section 52 is particularly apparent. Once again, the individual actuating element 5 also has a spring action section 51, for example similar to that explained with reference to FIG. 4.

FIG. 10 shows the rotary actuating element 6 of the conductor connection terminal according to FIGS. 1 and 7 as a single component. The multiple actuating arms 61 protruding from the ring-shaped main body 60 and having the angled actuating contours 62 are apparent.

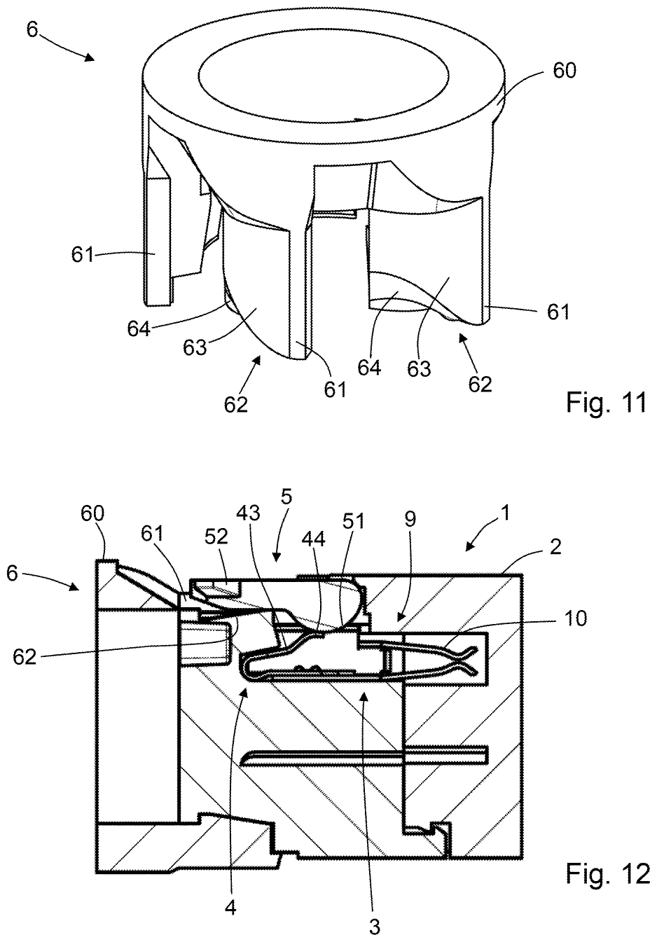

FIG. 11 shows a rotary actuating element 6 which likewise has a ring-shaped main body 60 and actuating arms 61 protruding from the main body 60. In each case an actuating contour 62 extending at an angle to the rotational direction D is formed on the actuating arms 61. Whereas in the example in FIG. 10 the actuating contours 62 are oriented in such a way that they are configured, at least predominantly, to transfer a force component that acts in the axial direction to the particular individual actuating element 5, FIG. 11 shows an example in which the actuating contours 62 are oriented in such a way that they are configured, at least predominantly, to transfer a force component that acts in the radial direction, in particular a radially outwardly acting force component. In this example, the actuating contour 62 may advantageously have a two-part design and may comprise a first partial contour 63 and a second partial contour 64. The spiral-shaped first partial contour 63 acts at the start of the opening movement. In the further course of the opening movement, the spiral-shaped/helical second partial contour 64 formed in the axial direction additionally acts. At the end of the opening movement the second partial contour 64, which is formed at the axial end-face side of the actuating arm 61, acts (almost) exclusively.

The rotary actuating element according to FIG. 11 may advantageously be used in a conductor connection terminal as illustrated in FIG. 12. The conductor connection terminal 1 once again has multiple spring-loaded clamping connections 9 in the housing 2, as well as an individual actuating element 5 associated with each spring-loaded clamping connection 9. In this case the individual actuating elements 5 are designed as swivelable actuating levers. Present once again at each individual actuating element 5 is a grip section 52 at which each individual actuating element 5 may be individually manually actuated by the user, in particular on the outer circumferential side of the housing 2. Each individual actuating element 5 has an eccentrically shaped spring action section 51 via which the particular clamping leg 43 is deflected when the individual actuating element 5 swivels, in that an actuating force is transferred from the eccentric spring action section 51 to the actuating section 44 of the clamping leg 43.

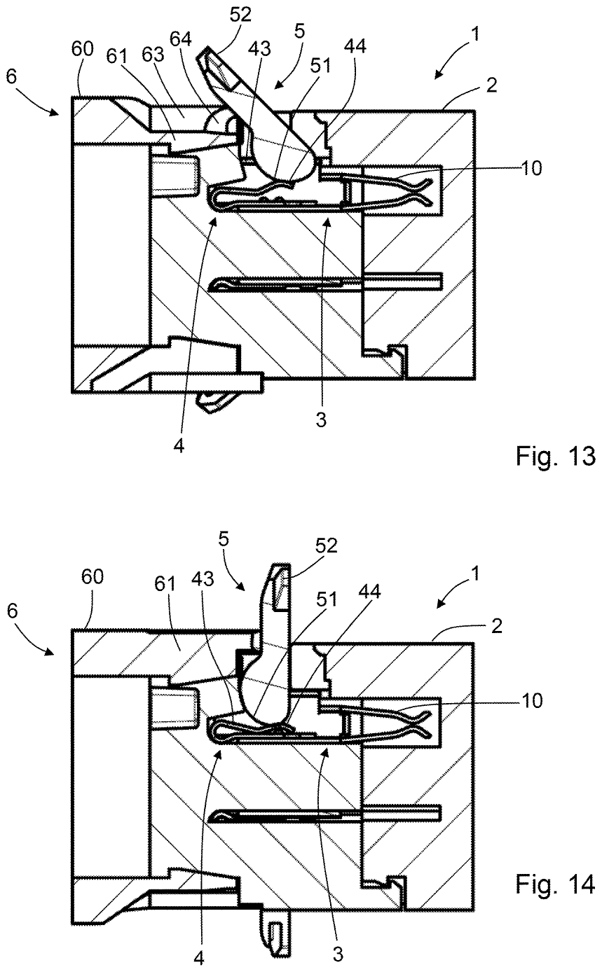

As illustrated in FIG. 13, the individual actuating elements 5 are configured to be swiveled outwardly, i.e., out of the housing 2, when the particular grip section 52 is manually actuated. In FIG. 13 the rotary actuating element 6 has already been rotated slightly, but not completely, in the rotational direction D. It is apparent that the clamping leg 43 is already moved slightly in the direction of the open position.

FIG. 14 shows the conductor connection terminal 1 according to FIG. 12 with the rotary actuating element 6 completely actuated. All individual actuating elements 5 are likewise now completely actuated via the rotary actuating element 6, and are in a top dead center position. In this position, the position of the individual actuating element 5 is held even if the rotary actuating element 6 is rotated back into the starting position. The force acting on the individual actuating element 5 by the clamping leg 43 does not reset the individual actuating element 5 in this top dead center position. To transfer the clamping leg 43 into the clamped position, the user must then manually actuate the respective individual actuating element 5 at the grip section 52 in order to move it back at least slightly in the direction of the starting position. The further moving back into the starting position may then take place via the restoring force that acts due to the clamping leg 43.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A conductor connection terminal comprising:
a housing; and
at least two spring-loaded clamping connections, each of which has at least one clamping spring for connecting an electrical conductor via an elastic force,
wherein for at least two or all of the spring-loaded clamping connections, the conductor connection terminal has an individual actuating element that is associated with each spring-loaded clamping connection and individually manually actuatable, and as a result of the manual actuation, the clamping spring of the associated spring-loaded clamping connection is individually actuatable into an open position, and
wherein the conductor connection terminal has at least one manually actuatable rotary actuating element that is rotatably supported on the housing, and as a result of its manual actuation via a rotational movement, the clamping spring of at least two or all spring-loaded clamping connections are jointly actuatable into the open position.

2. The conductor connection terminal according to claim 1, wherein the rotary actuating element is configured to indirectly actuate the particular clamping spring into the open position by actuating the individual actuating element associated with this clamping spring.

3. The conductor connection terminal according to claim 1, wherein the rotary actuating element has a main body from which at least two actuating arms protrude in the axial direction, wherein each actuating arm is configured to transmit an actuating force from the rotary actuating element to each individual actuating element or to a clamping leg of a clamping spring for deflecting the particular clamping leg into the open position.

4. The conductor connection terminal according to claim 3, wherein at least one actuating contour extending at an angle to the rotational direction of the rotary actuating element is formed at the particular actuating arm, and via which each individual actuating element or a clamping leg is adapted to be acted on with the actuating force from the rotary actuating element.

5. The conductor connection terminal according to claim 4, wherein the actuating contour is configured to apply an actuating force to each individual actuating element or to a clamping leg and the actuating force having at least one force component acting in the axial direction and/or at least one force component acting in the radial direction.

6. The conductor connection terminal according to claim 1, wherein one, at least two, or all individual actuating elements are designed as swivelable actuating levers or as displaceable push actuators or some other type of sliding actuation element.

7. The conductor connection terminal according to claim 1, wherein the spring-loaded clamping connections are arranged in a circular shape in the housing of the conductor connection terminal.

8. The conductor connection terminal according to claim 7, wherein the rotary actuating element has a ring-shaped main body that annularly surrounds the area delimited by the circular shape of the spring-loaded clamping connections.

9. The conductor connection terminal according to claim 8, wherein the rotary actuating element is configured to be manually actuated at its ring-shaped main body on a circumferential side of a ring-shaped housing of the conductor connection terminal.

10. The conductor connection terminal according to claim 7, wherein the individual actuating elements are configured to be actuated outside the area delimited by the circular shape of the spring-loaded clamping connections.

11. The conductor connection terminal according to claim 6, wherein the individual actuating elements are configured to be actuated inside the area delimited by the ring-shaped main body.

12. The conductor connection terminal according to claim 1, wherein the rotary actuating element is designed as an actuating element that is rotatable about the longitudinal axis of the circular shape of the spring-loaded clamping connections.

13. The conductor connection terminal according to claim 1, wherein upon reaching the open position, one, multiple, or all individual actuating elements are in each case fixable to at least one component of the conductor connection terminal or fixable in a top dead center position, wherein in the fixed position of the individual actuating element, and wherein the clamping leg is held in the open position by the individual actuating element.

14. The conductor connection terminal according to claim 1, wherein the individual actuating element has a first detent element with which the individual actuating element is latchable, in the open position, to a second detent element of another component of the conductor connection terminal or the busbar or the housing.

15. The conductor connection terminal according to claim 1, wherein the conductor connection terminal has a release element with a release section in each case for one, at least two, or all spring-loaded clamping connections, via which the fixing or latching of the particular individual actuating element is releasable in the open position and the clamping leg is automatically movable from the open position in the direction of the clamped position when the release section is acted on with a release force by the inserted electrical conductor.

16. An electrical plug connector, in particular circular plug connector, comprising at least one conductor connection terminal according to claim 1.
